(19) United States
(12) Patent Application Publication
(10) Pub. No.: US 2021/0150617 A1
(43) Pub. Date: May 20, 2021

(54) SYSTEM AND METHOD FOR MULTI-ITEM TRANSACTIONS

(71) Applicants: Tomasz Kolosowski, Mississauga (CA); Julian Sarboiu, Tottenham (CA)

(72) Inventors: Tomasz Kolosowski, Mississauga (CA); Julian Sarboiu, Tottenham (CA)

(21) Appl. No.: 16/690,059

(22) Filed: Nov. 20, 2019

(51) Int. Cl. G06Q 30/06; G06Q 30/08; G06N 20/00; G06Q 30/02

(52) U.S. Cl. CPC G06Q 30/0643; G06Q 30/0639; G06Q 30/0253; G06Q 30/08; G06N 20/00; G06Q 30/0631

(57) ABSTRACT

The present invention relates to a system for listing and transacting multiple items for sale concurrently, where the transaction is completed at a physical location between a seller and a buyer, the system including: a global parameter database, the global parameters including the physical location and a time window for completing transactions, the global parameters provided by the seller; an item parameter database, the item parameters including an item title, an item description and an item price; an item gallery database, the item gallery database including data for one or more items, each item associated with the global parameters and at least one item parameter, the item gallery database searchable by the buyer; and a transaction engine, the transaction engine comprising a user interface enabling the buyer to arrange a transaction to buy one or more of the items from the seller; wherein the physical location and time window are associated with a physical event, the physical event being an event for transacting the items.

### FIELD OF THE INVENTION

The present specification relates generally to systems and methods for online transactions, and more particularly to a system and method for listing and transacting multiple items concurrently.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

Developments in internet access have led to a modernization of transactions between individuals. Online services such as eBay, Kijiji, and LetGo enable users to buy or sell items through the service. Some services integrate payment systems, while others leave payment to be negotiated between the parties.

However, these services are geared towards posting one item at a time for sale and attempting to post multiple items can be extremely time-consuming. This issue can be exacerbated as communications are received separately for each item, leading to challenges for the user to track multiple inquiries and potentially interested parties for transactions. These challenges extend further into arranging for payment, and to the eventual physical exchange of the product, where necessary.

Therefore, while there are some online transaction systems known in the art, it would be desirable to have a system and method for online transactions which mitigates some of the disadvantages described above.

Accordingly, there remains a need for improvements in the art.

### SUMMARY OF THE INVENTION

In accordance with an aspect of the invention, there is provided a system and method for listing and transacting multiple items concurrently.

According to an embodiment of the invention, there is provided a system for listing and transacting multiple items for sale concurrently, where the transaction is completed at a physical location between a seller and a buyer, the system including: a global parameter database, the global parameters including the physical location and a time window for completing transactions, the global parameters provided by the seller; an item parameter database, the item parameters including an item title, an item description and an item price; an item gallery database, the item gallery database including data for one or more items, each item associated with the global parameters and at least one item parameter, the item gallery database searchable by the buyer; and a transaction engine, the transaction engine comprising a user interface enabling the buyer to arrange a transaction to buy one or more of the items from the seller; wherein the physical location and time window are associated with a physical event, the physical event being an event for transacting the items.

The system may further include one or more of a pricing engine, where the pricing engine provides a price adjustment to one or more item prices based on monitored item gallery data; an advertising engine, the advertising engine providing advertising associated with the item gallery based on one or more of the global parameters and the item parameters; and a machine learning engine operative to present the seller with pre-selected recommendations for item parameters according to data from item galleries and past transactions and allowing the seller to accept, reject or defer the decision to a later time/date on the pre-selected recommendations.

According to a further embodiment of the invention, there is provided a method for listing and transacting multiple items for sale concurrently where the transaction is completed at a physical location between a seller and a buyer, the method comprising: collecting global parameters from the seller, the global parameters including the physical location and a time window for completing transactions; collecting item parameters for each item from the seller, the item parameters including an item title, an item description and an item price; generating an item gallery, the item gallery including all items associated with the global parameters, the item gallery generated in a format searchable by both global parameters and item parameters; displaying the item gallery in response to a search request from the buyer, the search request including one or more of the global parameters and item parameters; and generating and recording a transaction agreement between the seller and the buyer associated with one or more of the items, when an indication of the transaction agreement is received, wherein the physical location and time window are associated with a physical event, the physical event being an event for transacting the items.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a block diagram of an operating environment for a transaction system according to an embodiment of the present invention;

FIG. 2 is as block diagram of a transaction system according to an embodiment of the present invention; and

FIG. 3 is a flowchart of a transaction process according to an embodiment of the present invention.

Like reference numerals indicated like or corresponding elements in the drawings.

### DETAILED DESCRIPTION OF THE EMBODIMENTS

The present invention relates to systems and methods for online transactions and, in particular, a system and method for listing and transacting multiple items concurrently.

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

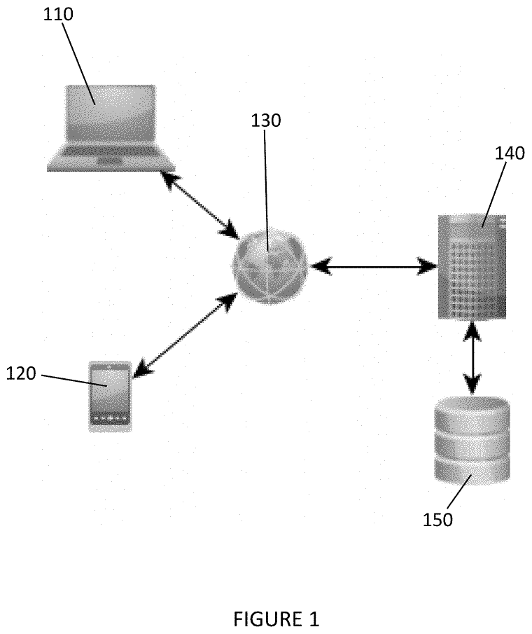

According to an embodiment as shown in FIG. 1, the operating environment for a listing and transaction system is shown. The system operates on a server 140 which is connected to one or more databases 150. A seller may access the server 140 from a seller client device 110 via the Internet 130. Similarly, a buyer may access the server 140 from a buyer client device 120 via the Internet 130. The client devices 110, 120 may be a computer, a tablet, a mobile device, a dedicated terminal, or other computer device having an input mechanism and a display as is known in the art. FIG. 1 is shown with single devices for clarity, however, it is to be understood, as discussed above, embodiments may comprise multiple client devices 110, 120, servers 140 and databases 150.

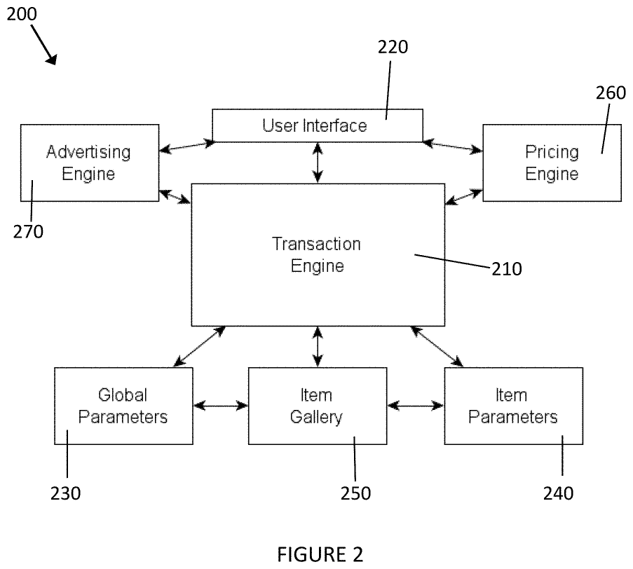

The listing and transaction system 200 is shown in greater detail in the block diagram of FIG. 2. The center of the system 200 is the transaction engine 210, which operates, integrates and controls the other components of the system 200. A user interface 220 enables sellers and buyers to interact with the transaction engine 210 and input information and receive displayed information as discussed below. A global parameters database 230 stores global parameters input by sellers, and may also store recommended or standard global parameters created by the system 200. Similarly, an item parameters database 240 stores the item parameters input by sellers and may also store any recommended or standard item parameters created by the system 200. An item gallery database 250 stores the item galleries created by the users as described below. Other optional components may include a pricing engine 260 operative to provide item price recommendations to the sellers and an advertising engine 270 to display advertising to sellers and buyers, and track advertising results for the purpose of providing compensation, if required.

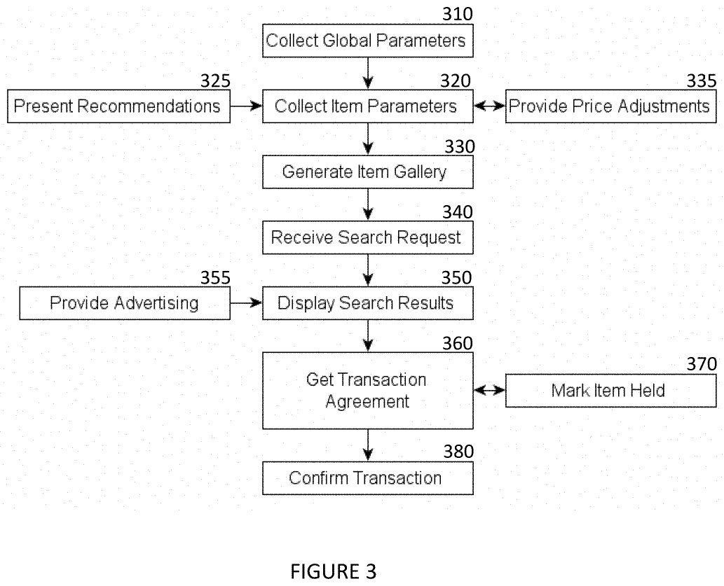

A flowchart for a method of operating the listing and transaction system 200 is shown in FIG. 3. A first step 310 is to collect the global parameters associated with the items. The seller is presented with a user interface to input the global parameters which apply to all the listed items for sale. The primary global parameters are the physical location for item exchange once a transaction is agreed upon, and the time windows (dates and times) when the exchange may take place. Other potential global parameters may include accepted payment methods and any global keywords associated with the collective items (e.g. “electronics”, “furniture”, etc.). The user may input the parameters on their own, or be provided with preset parameters through dropdown menus, checkboxes, and the like.

Once the global parameters are collected, the next step 320 is to collect the item parameters for each of the items being offered for sale. The seller may proceed to input the item parameters through the user interface. The primary item parameters are an item description and a price. The item description may further be divided into a short description or title of one or two words (e.g. “computer”, “chair”) and a long description where additional details (size, color, technical information, etc.) are provided. Similarly, the price may include a starting price, a minimum price, and whether the item is subject to price adjustments (discussed further below). Other item parameters may include one or more images, and specific keywords associated with the item (e.g. “laptop”, “folding chair”). As with the global parameters, the item parameters may be freely input by the user, or may be provided through dropdowns, checkboxes, etc. In particular, the user may be presented with proposed price and keyword options based on analysis of other items historically transacted through the system.

With all items (and associated item parameters) input, the system proceeds to generate 330 an item gallery associated with the seller. The item gallery is comprised of all the items for sale from the seller categorized according to their item parameters and posted for sale under the associated global parameters. Notably the physical location and time may be further associated with an event such as garage sale (also referred to as a “yard sale”, “contents sale” or “street sale”, depending on locality) or flea market, where the user may have the opportunity to sell items that have not already had a sale arranged through the system. Thus, in addition all the items input by the user, and the associated item parameters and global parameters, the item galley may also include any information associated with the physical event.

The displayed item galleries may be rotated for visibility according to different methods of priority according to different priority factors. Traditionally, such displays are presented according to priority factors such as posting and/or event date, with either newest postings or events closest to expiring being preferred. Another method is to rotate the item galleries on a pre-determined basis (e.g. every few hours) through all available galleries, independently of the original posting date or event date. Other methods and priority factors may include popularity, with items and item galleries with more views/hits having greater or lesser priority for display. Finally, a fee payment system may be implemented, where the seller pays a fee for display priority, overriding any other system.

Accordingly, from the buyer's side, searches may be conducted according to the buyer's availability to complete the transaction by starting with a desired geographic region and time range. Item galleries which have matching global parameters may then be presented as positive search results. Alternatively, searches may be conducted according to the item parameters, particularly the title and description, and specific items matching the search may be presented with their associated global parameters for the buyer to assess.

For example, searches may be conducted by keyword, where the buyer is looking for a particular item. The system receives the search request 340 and then generates search results by matching the keyword against item parameters (e.g. title, description, category) within the item galleries. The matching items and item galleries are then displayed 350 to the buyer accordingly. Alternatively, searches may conducted by geographic area (city/town, postal/zip code, street address) and the results displayed as a selection of item galleries (i.e. garage sales) matching the search parameters. Results may be displayed graphically as a map, and the buyer may manipulate the map to generate and display enhanced results. The displayed map may further include aspects to refine and clarify the results, such as overlays for geographic range, and the ability for the buyer to manually highlight and select part or all of the geographic area by using highlighting tools.

The displayed item galleries may be further enhanced and differentiated from others through emphasis in the display. Emphasis may be provided by showing matching items in color, while non-matching items are in greyscale or masked, by increasing the size of matching items, or by showing an enhanced border around the matching items. Depending on the parameters, the number of items shown and the type of emphasis may be determined by the detected display type (e.g. phone/tablet/monitor, screen resolution, etc.).

By implementing the physical location as a global parameter, prospective buyers are thereby able to search by both location and time, enabling them to compare available items and arrange collection from multiple sellers with proximate physical locations and time availability. Additionally, mapping and routing information may be generated for export to another application, such as Google Maps or Waze.

To facilitate transactions and limit the time requirements on both the seller and the buyer, a question/answer system may be provided. The buyer may input a question, either freeform, or from a dropdown or similar selection menu of common questions. Before contacting the seller, the questions may be parsed for keywords and previously submitted questions and answers displayed to the buyer for review. If the desired answer is not displayed, the seller is then notified and prompted to submit a response. The response and questions are then made visible and added to the item parameters for the item associated with the question. In this way, the system allows for additional data to be associated with an item, as well as eliminating repetitive questions to the seller from separate buyers.

To further assist users in selling items more efficiently, a pricing system to provide price adjustments 335 may be incorporated at the seller's discretion. The seller may be required to provide a minimum set price (which may be zero or $0.01) as part of the item parameters for each item, in addition to a listing price. The minimum set price therefore must be met by a buyer in order to arrange and complete a transaction. The minimum set price may also be concealed from the buyer where an auction-based system is in place, to maintain integrity.

Starting with the listing price and the minimum set price, the simplest setting for the pricing system has the listing price adjusted (either increased or decreased) by a set amount (absolute or percentage value) after a fixed number of days. The price adjustment may be repeated until either a maximum/minimum set price is reached (per the item parameters) or a fixed amount of total increase/decrease (again, absolute or percentage) is reached. For example, the price of an item may be reduced by 10% every three days until a 50% reduction is reached (or the item is sold).

More advanced pricing systems may also be incorporated. For example, the number of hits or views associated with the item may be incorporated such that the items with fewer hits either have their price adjusted by a larger increment, or in fewer days, or both. Data from sales of similar items may also be applied to suggest both the type and amount of price adjustment. For example, the price of an item may be increased by $5 every time a similar item is sold, to reflect increased demand and decreased supply.

Finally, rather than automatically adjusting the price, the system may request confirmation from the seller before proceeding. This confirmation may be required as part of each request, with the option for the seller to accept/reject all further requests. The seller may also defer the decision to accept/reject for a fixed or variable period of time. The seller may also re-enter the system and manually adjust the listing price and/or minimum set price at any time as long as the item is unsold.

Once a buyer has agreed to a transaction 360, the item may be marked as “held” or “sold” 370 and will not appear in any further search results. If there are multiple of the same item, the prices for the unsold items may also be fixed at the sale price, at the seller's discretion. The buyer may then pay immediately or arrange for payment at pickup, according to the payment method and requirements of the seller as contained in either the global parameters or the item parameters. The transaction and pickup may then take place in the location and time window set in the global parameters. For specific items, the seller may set the item parameters to require partial or full payment in advance, if desired. If the transaction does not take place as a result of non-appearance by either party, it may be reported to the system for tracking.

Also, as a physical meeting is scheduled, the payment method for concluding the transaction may include a barter (goods) exchange or service exchange as payment as an alternative to payment through currency (physical or digital) at the seller's discretion and/or settings.

Once the transaction is completed, either the seller or the buyer may confirm 380 with the system that the transaction was successful. Alternatively, if the transaction was not completed, either the buyer or seller may report it to the system, along with any additional details surrounding the non-completion. Successful and unsuccessful transactions for buyers and sellers may be tracked and included in future proposed sales or transactions.

If a buyer has arranged to buy multiple items from multiple sellers, the system may also provide the option to generate a travel itinerary for the buyer to optimize travel time and distance for item pickups using an itinerary engine. Similarity, where a buyer has identified multiple physical events (e.g. garage sales) to attend in a specified time window (e.g. Saturday, between noon and 4 pm), the system may generate a similar itinerary to optimize travel time and distance in accordance with the location and time window for each identified physical event and/or arranged item pickup.

When viewing the map and/or itinerary, the buyer may be further provided with tools to manually adjust or modify the presented information. For example, the buyer may wish to change the starting point or end point and view the changes to the route/itinerary. As another example, the buyer may be able to highlight specific regions or geographical areas of the map, either manually or through pre-defined region parameters, to assist in selecting events and locations.

Additionally, the seller may be provided with the option to contact a third party, such as a charity or similar organization to collect unsold items, once the time window has closed. Other potential third party services may include storage/moving companies, if the items are to be kept by the seller. Alternatively, the seller may repost the items by merely changing the global parameters. This feature may be useful to sellers with ongoing or repeat sale events, such as flea markets and auctions. Similarly, third party services such as pickup/delivery services may be offered to the buyer, including providing an itinerary as discussed above. The system may provide recommended third parties, and may offer incentives or compensation for using the recommended third parties.

Another third party option may be to provide surrogate hosts to the seller for the physical event. For example, a community center or flea market may offer tables at an event, which would be provided as an option to sellers who may lack the physical space or opportunity to host their own physical event. Other third party services offered may include signage, display racks and other items and services to assist with the physical event. Where a surrogate host is used, this may be indicated through the use of different colors or markers on the search results, including any map overlays, to indicate such to the buyer. Compensation and/or incentives may be offered to potential surrogate hosts to encourage participation.

The system may thereby further act as a promotional tool for physical sale events (garage sales, flea markets, pop-up sales). Accordingly, advertising may be offered to the seller to select for association with the item gallery. Appropriate advertising may be selected by analysis of the global parameters and item parameters to select products and services to be advertised that are associated with the analyzed parameters. The advertising may then be displayed 355 as part of the search results in order to attract the buyers. Displayed advertising may be page banner ads, overlay ads, pop-up or link-out ads, or other forms as known in the art. Advertising may be displayed in a fixed or variable position, and for a fixed or variable time. The advertising may also act as a further monetization option for sellers by providing compensation when advertising associated with the seller's item gallery is successfully executed.

The seller may additionally have pre-defined preferences for advertising, which may include preferring certain advertisers or banning certain advertisers. The advertisers may be selected individually or collectively. The seller may further select specific advertisers to be promoted, which may or may not have a relationship with the seller.

Alternatively, some systems may prohibit advertising, and operate by collecting fees from the sellers. Such fees could include posting fees, additional promotional fees (e.g. pay a fee for higher listing), renew fees, or other fees as known in the art.

The system may also comprise the capability to present recommendations 325 to the sellers during the input of the item parameters. For example, the system may present one or more recommended categories based on the item title which was input. Similarly, a recommend minimum or listing price may be presented based on the item title and category. The recommendations may be derived from past item gallery data, past transaction data (successful and unsuccessful), as well as from similar items currently listed. The seller may adopt the recommendations or proceed with manual input, at their preference. Optionally, one or more of the items and/or item galleries used in generating the recommendations may also be displayed to the seller for reference.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preferences, user preferences, marketing preferences, cost, structural requirements, available materials, technological advances, etc., other methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A system for listing and transacting multiple items for sale concurrently, where the transaction is completed at a physical location between a seller and a buyer, the system comprising:
a global parameter database, the global parameters including the physical location and a time window for completing transactions, the global parameters provided by the seller;
an item parameter database, the item parameters including an item title, an item description and an item price;
an item gallery database, the item gallery database including data for one or more items, each item associated with the global parameters and at least one item parameter, the item gallery database searchable by the buyer; and
a transaction engine, the transaction engine comprising a user interface enabling the buyer to arrange a transaction to buy one or more of the items from the seller;
wherein the physical location and time window are associated with a physical event, the physical event being an event for transacting the items.

2. The system of claim 1, wherein the physical event is one of a garage sale, a flea market, and an auction.

3. The system of claim 1, further comprising a pricing engine, the pricing engine providing a price adjustment to one or more item prices based on monitored item gallery data.

4. The system of claim 3, wherein monitored item gallery data includes one or more of: duration of listing, number of item gallery views, number of item views, number of similar items listed, prices of similar items listed, and transactions of similar items listed.

5. The system of claim 3, wherein the pricing engine further provides the seller with an option on the price adjustment to select one of: accept the price adjustment, reject the price adjustment and defer a decision on the price adjustment.

6. The system of claim 1, further comprising an advertising engine, the advertising engine providing advertising associated with the item gallery based on one or more of: the global parameters, the item parameters, seller-defined preferences and seller-selected advertisers.

7. The system of claim 6, wherein the advertising engine further includes an associated payment system.

8. The system of claim 1, further comprising a machine learning engine operative to present the seller with pre-selected recommendations for item parameters according to data from item galleries and past transactions and allowing the seller to accept/reject the pre-selected recommendations.

9. The system of claim 8, wherein the machine learning engine is further operative to present the user with ongoing recommendations for changes to existing item parameters according to data from item galleries and past transactions and allowing the seller to accept/reject the ongoing recommendations.

10. The system of claim 1, further comprising an itinerary generation engine operative to generate an itinerary for the buyer, the itinerary comprising one or more of: a list of physical events, a list of arranged transactions, a travel route and a map.

11. The system of claim 1, wherein item gallery selection comprises selecting the item gallery according to a priority system, the priority system comprising one or more priority factors, the priority factors including at least one of: posting date, event date, number of item views, and number of gallery views.

12. A method for listing and transacting multiple items for sale concurrently where the transaction is completed at a physical location between a seller and a buyer, the method comprising:
collecting global parameters from the seller, the global parameters including the physical location and a time window for completing transactions;
collecting item parameters for each item from the seller, the item parameters including an item title, an item description and an item price;
generating an item gallery, the item gallery including all items associated with the global parameters, the item gallery generated in a format searchable by both global parameters and item parameters;
displaying the item gallery in response to search request from the buyer, the search request including one or more of the global parameters and item parameters; and
generating and recording a transaction agreement between the seller and the buyer associated with one or more of the items, when an indication of the transaction agreement is received,
wherein the physical location and time window are associated with a physical event, the physical event being an event for transacting the items.

13. The method of claim 12, wherein the physical event is one of a garage sale, a flea market, and an auction.

14. The method of claim 12, further comprising providing price adjustment to one or more item prices based on monitored item gallery data.

15. The method of claim 14, wherein monitored item gallery data includes one or more of: duration of listing, number of item gallery views, number of item views number of similar items listed, prices of similar items listed, and transactions of similar items listed.

16. The method of claim 14, further comprising providing the seller with an option on the price adjustment to select one of: accept the price adjustment, reject the price adjustment and defer a decision on the price adjustment.

17. The method of claim 12, further comprising providing advertising associated with the item gallery based on one or more of: the global parameters, the item parameters, seller-defined preferences and seller-selected advertisers.

18. The method of claim 17, wherein providing advertising further includes an associated payment system.

19. The method of claim 12, further comprising presenting the seller with pre-selected recommendations for item parameters according to data from item galleries and past transactions and allowing the seller to accept/reject the pre-selected recommendations.

20. The method of claim 19, further comprising presenting the seller with ongoing recommendations for changes to existing item parameters according to data from item galleries and past transactions and allowing the seller to accept/reject the ongoing recommendations.

21. The method of claim 12, further comprising generating an itinerary for the buyer, the itinerary comprising one or more of: a list of physical events, a list of arranged transactions, a travel route and a map.

22. The method of claim 12, wherein displaying the item gallery further comprises selecting the item gallery according to a priority system, the priority system comprising one or more priority factors, the priority factors including at least one of: posting date, event date, number of item views, and number of gallery views.
